(19) United States
(12) Patent Application Publication
(10) Pub. No.: US 2002/0163169 A1
(43) Pub. Date: Nov. 7, 2002

(54) Vehicle occupant restraint system comprising a side gas bag module

(75) Inventor: Anton Fischer, Leinweiler (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/135,217

(22) Filed: Apr. 30, 2002

(30) Foreign Application Priority Data
May 2, 2001 (DE) 101 21 304.2

(51) Int. Cl. B60R 21/22

(52) U.S. Cl. 280/730.2

(57) ABSTRACT

The invention relates to a vehicle occupant restraint system, comprising a side gas bag module which contains a gas bag folded into an elongated packet and having inner and outer sides when unfolded. The gas bag packet has an underside and a side face adjoining thereto and is surrounded by a flexible protective covering which has a predetermined tear line along the side face, so that the protective covering, on an unfolding of the gas bag, opens in a region of the side face of the gas bag packet and two sections of the protective covering, which are of differing length, extend along the inner and outer sides of the unfolded gas bag.

### TECHNICAL FIELD

The invention relates to a vehicle occupant restraint system.

### BACKGROUND OF THE INVENTION

Known vehicle occupant restraint systems comprise a side gas bag module which contains a gas bag folded into an elongated packet and having inner and outer sides when unfolded, the gas bag packet having an underside and a side face adjoining thereto, and the gas bag packet being surrounded by a flexible protective covering. In such side gas bag modules, a stable but at the same time bulky and voluminous housing is dispensed with. The gas bag, which is wrapped into the protective covering, is fastened for example directly under the headliner of the vehicle or under a roof frame lining.

### BRIEF SUMMARY OF THE INVENTION

The invention faces the problem of improving the unfolding behavior and the operating reliability of such a side gas bag module in a simple manner.

This is achieved in a vehicle occupant restraint system comprising a side gas bag module which contains a gas bag folded into an elongated packet and having inner and outer sides when unfolded. The gas bag packet has an underside and a side face adjoining thereto and is surrounded by a flexible protective covering which has a predetermined tear line along the side face, so that the protective covering, on an unfolding of the gas bag, opens in a region of the side face of the gas bag packet and two sections of the protective covering, which are of differing length, extend along the inner and outer sides of the unfolded gas bag. The sections of the protective covering of different length are produced, viewed in longitudinal extent of the elongated gas bag packet. The longer section of the protective covering can be placed, on unfolding of the gas bag, against a vehicle contour, e.g. an outer wall of the vehicle or a lining piece, and can thereby prevent the unfolding gas bag from getting caught on such a contour or even being damaged.

In addition, the unfolding behavior of the gas bag can also be positively influenced. Speed and uniformity of unfolding of the gas bag over the length of the gas bag packet are determined inter alia by the friction between the gas bag fabric and the vehicle parts with which the gas bag comes into contact during its unfolding. As the gas bag according to the invention is in contact with the longer section of the protective covering during its initial unfolding phase, a favorable sliding behavior of the gas bag along the protective covering can be made use of, so that for example differingly rough areas of the outer face of the vehicle along the gas bag packet do not play any part.

Preferably, therefore, the longer section of the protective covering is arranged and designed such that it serves as a sliding surface for the gas bag during unfolding, in order to achieve a uniform unfolding of the gas bag over the entire width of the gas bag. In this case, the protective covering extends along the entire gas bag packet, so that a favorable coefficient of friction between the inner face of the protective covering and the gas bag can be made use of.

However, it is also conceivable that the protective covering is only provided in places which in the installed state correlate with an interfering vehicle contour. An unfavorable friction coefficient of this vehicle contour with the gas bag can then be avoided in that the longer section covers this vehicle contour, so that the gas bag, during its unfolding, slides along the inner face of the longer section and not along the vehicle contour.

The protective covering can consist of a foil or a fabric layer, which advantageously has a special coating on the inner face.

The longer section of the protective covering preferably extends as far as into the interior of the vehicle. It is advantageously so long that it can cover, as fully as possible, interfering vehicle contours or sharp edges of a lining, in order to serve as a protection for the gas bag. The vehicle contour can, for example, be a head piece of a lining of a B-column or a C-column.

Preferably, the side face, in an installed state of the side gas bag module on the vehicle, faces the interior of the vehicle. In this way, the longer section of the protective covering can be placed between the gas bag and the roof frame, which is advantageous, because the unfolding direction of the gas bag is generally selected such that the latter unfolds directed towards the exterior of the vehicle. The longer section of the protective covering can thus protect the gas bag from sharp edges and vehicle contours, along which the gas bag moves.

The protective covering can consist of a single fabric section, the ends of which are sewn together along the side face. The tear line is then preferably formed along the seam. In this case, the protective covering tears open along the seam, with the material, in the case of a foil, preferably tearing between the holes through which the thread of the seam runs, similar to a perforation, whereas in the case of a fabric the seam is preferably designed such that it is weaker than the fabric, so that, on opening of the protective covering, the seam tears. The tear line can also be realized in any other desired, known manner.

### BRIEF DESCRIPTION OF THE DRAWINGS

FIG. 1 shows a perspective view of a side gas bag module of a vehicle occupant restraint system according to the invention; and

FIG. 2 shows a section through a roof frame region of a vehicle with a vehicle occupant restraint system according to the invention, provided with the side gas bag module of FIG. 1 during unfolding of the gas bag.

### DETAILED DESCRIPTION OF THE PREFERRED EMBODIMENT

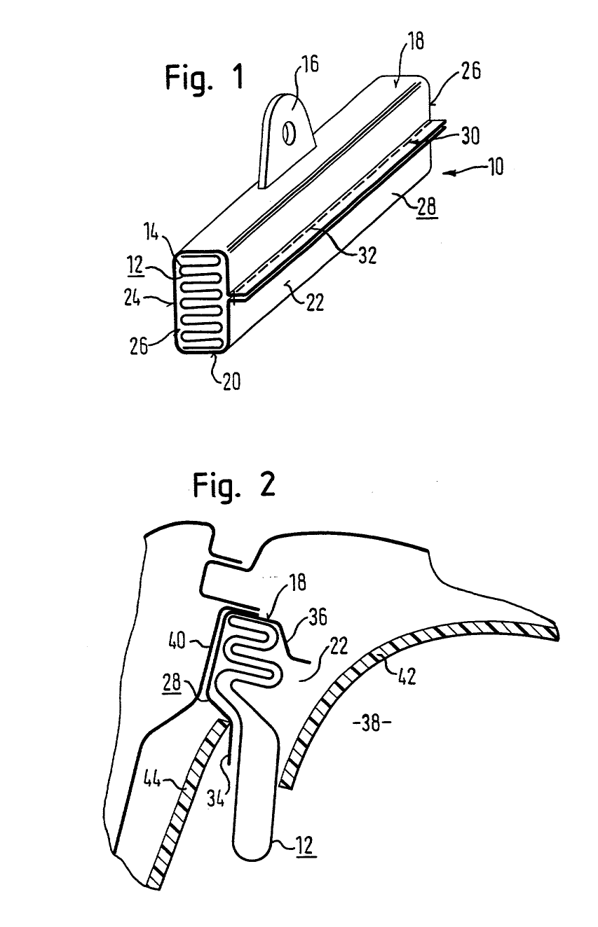

FIG. 1 shows a side gas bag module 10 of a vehicle occupant restraint system according to the invention, with a gas bag 12 which is folded into an elongated gas bag packet 14. The gas bag 12 has fastening tongues 16, only one of which is shown and with which the side gas bag module 10 can be fastened to a vehicle. The fastening tongues 16 are situated on an upper face 18 of the gas bag packet, which face is arranged opposite an underside 20. The underside 20 extends in the installed state approximately perpendicularly to a preferred outlet direction of the gas bag 12. Two side faces 22, 24 adjoin the underside 20 and extend between the upper side 18 and the underside 20. In addition, the gas bag packet 14 also has end faces 26.

The gas bag packet 14 is surrounded at least on the side faces 22, 24 and also the upper side 18 and the underside 20 by a flexible protective covering 28, which can consist for example of a foil or of a fabric layer. The end faces 26 of the gas bag packet 14 can likewise be covered by the protective covering 28.

The protective covering 28 is preferably constructed in one piece, the ends of the protective covering 28 being connected with each other approximately in the center of the side face 22. This connection can take place by gluing or, as illustrated in FIG. 1, by a seam 32. On the side face 22, a tear line 30 is arranged, which in the example embodiment shown here lies in the region of the seam 32. Along this tear line 30, the protective covering 28 opens on unfolding of the gas bag on activation of the side gas bag module 28.

Owing to the arrangement of the tear line 30 in the region of the side face 22, two sections 34, 36 of the protective covering, which are of differing lengths, are produced after the opening of the protective covering 28, viewed in longitudinal direction of the gas bag packet 14.

As is shown in FIG. 2, the side gas bag module 10 is mounted on a vehicle such that the side face 22 with the tear line 30 faces a vehicle interior 38. With this arrangement, the longer section 34 of the protective covering then extends along the roof frame 40 of the vehicle. The side gas bag module 10 is fastened to the vehicle such that before the unfolding of the gas bag 12, it is concealed under a roof 42.

On activation of the side gas bag module 10, the gas bag 12 begins to unfold and in so doing exerts pressure onto the protective covering 28. This opens along the tear line 30, and the unfolding gas bag 12 pushes the roof 42 open, in order to enter into the vehicle interior 38. In the region of the vehicle exterior 40, there are vehicle contours 44 which may have sharp edges and lie close to the unfolding gas bag 12. The vehicle contour 44 can be, for example, a B-column lining and in particular a head piece of a B-column lining 44 or else a C-column lining and in particular the upper edge of the C-column lining. The longer section 34 of the protective covering 28, directly after opening of the protective covering 28, lies over such vehicle contours 44 and covers these. The gas bag 12 can thereby unfold unimpeded and without risk of damage.

The interior of the protective covering 28 can be provided with a special coating, in particular in the region of the longer section 34, in order to have particular desired friction characteristics. In this way, the unfolding of the gas bag 12 can be additionally influenced.

The protective covering 28, as shown in FIG. 1, can extend over the entire width of the gas bag, but it is also possible for the protective covering 28 to surround the gas bag packet 14 only in selected areas, which for example correlate with the head 44 of the B-column lining.

1. A vehicle occupant restraint system, comprising a side gas bag module which contains a gas bag folded into an elongated packet and having inner and outer sides when unfolded, said gas bag packet having an underside and a side face adjoining thereto, and said gas bag packet being surrounded by a flexible protective covering which has a predetermined tear line along said side face, so that said protective covering, on an unfolding of said gas bag, opens in a region of said side face of said gas bag packet and two sections of said protective covering, which are of differing length, extend along said inner and outer sides of said unfolded gas bag.

2. The vehicle occupant restraint system according to claim 1, wherein said side face, in a state of said side gas bag module installed on said vehicle, faces a vehicle interior.

3. The vehicle occupant restraint system according to claim 1, wherein the longer one of said two sections of said protective covering extends as far as into said vehicle interior.

4. The vehicle occupant restraint system according to claim 1, wherein the longer one of said two sections of said protective covering lies between said gas bag and a roof frame of said vehicle.

5. The vehicle occupant restraint system according to claim 1, wherein the longer one of said two sections covers a vehicle contour, in order to serve as a protection for said gas bag.

6. The vehicle occupant restraint system according to claim 5, wherein said vehicle contour is a lining of a B-column.

7. The vehicle occupant restraint system according to claim 1, wherein the longer one of said two sections of said protective covering is arranged and designed such that it serves as a sliding surface for said gas bag during unfolding.

8. The vehicle occupant restraint system according to claim 1, wherein said protective covering consists of one of a foil and a fabric layer.
